(19) United States
(12) Patent Application Publication
(10) Pub. No.: US 2007/0222130 A1
(43) Pub. Date: Sep. 27, 2007

(54) QUICK RELEASE MECHANISM

(75) Inventors: Paul C. Leinbach, Buffalo, MN (US); Steve Krohmer, Coon Rapids, MN (US); Nicholas Powley, St. Paul, MN (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Rockler Companies Incorporated, Medina, MN (US)

(21) Appl. No.: 11/534,432

(22) Filed: Sep. 22, 2006

Related U.S. Application Data
(60) Provisional application No. 60/785,266, filed on Mar. 23, 2006.

(51) Int. Cl. B25B 1/00

(52) U.S. Cl. 269/6

(57) ABSTRACT

A quick release mechanism is adapted to actuate a stack of at least one clutch plate of a clamp assembly. The assembly includes a beam and a jaw with a housing having the stack disposed therein. The quick release mechanism is positioned around an outer surface of the housing. The quick release mechanism also includes a handle and a clutch plate engaging portion adapted to engage the stack.

### CROSS-REFERENCE TO RELATED APPLICATION

The present application is based on and claims the benefit of U.S. provisional patent application Ser. No. 60/785,266, entitled “QUICK RELEASE SYSTEM FOR PIPE AND BAR CLAMP” filed Mar. 23, 2006, the content of which is hereby incorporated by reference in its entirety.

### BACKGROUND

Clamps are used in a number of workshop settings. Two such clamps include bar clamps and pipe clamps. Typical bar and pipe clamps include a beam (which can be a bar or a pipe) and first and second jaws positioned on the beam. One or both of the jaws can be positioned along a length of the beam. At least one of the jaws can include a stack of one or more clutch plates that are coupled to the jaw. A biasing element forces the stack of one or more clutch plates to engage the beam such that the jaw is locked in place with respect to the beam. To actuate the jaw, the clutch plates of the stack are released from the beam such that the jaw can move relative thereto. Due to its limited size, the stack can be difficult to release from the beam.

### SUMMARY

A quick release mechanism is adapted to actuate a stack of at least one clutch plate of a clamp assembly. The assembly includes a beam and a jaw with a housing having the stack disposed therein. The quick release mechanism is positioned around an outer surface of the housing. The quick release mechanism also includes a handle and a clutch plate engaging portion adapted to engage the stack.

A method operates a clamp assembly including a beam and a jaw. The jaw has a housing having a stack of at least one clutch plate disposed therein. The method includes providing a quick release mechanism including a handle and a clutch plate engaging portion adapted to engage the stack. The method includes positioning the quick release mechanism around an outer surface of the housing.

This summary is not intended to describe each disclosed embodiment or every implementation of the present invention. Many other novel advantages, features, and relationships will become apparent as this description proceeds. The figures and the description that follow more particularly exemplify illustrative embodiments.

### BRIEF DESCRIPTION

The present invention will be further explained with reference to the attached figures, wherein like structure or system elements are referred to by like reference numerals throughout the several views.

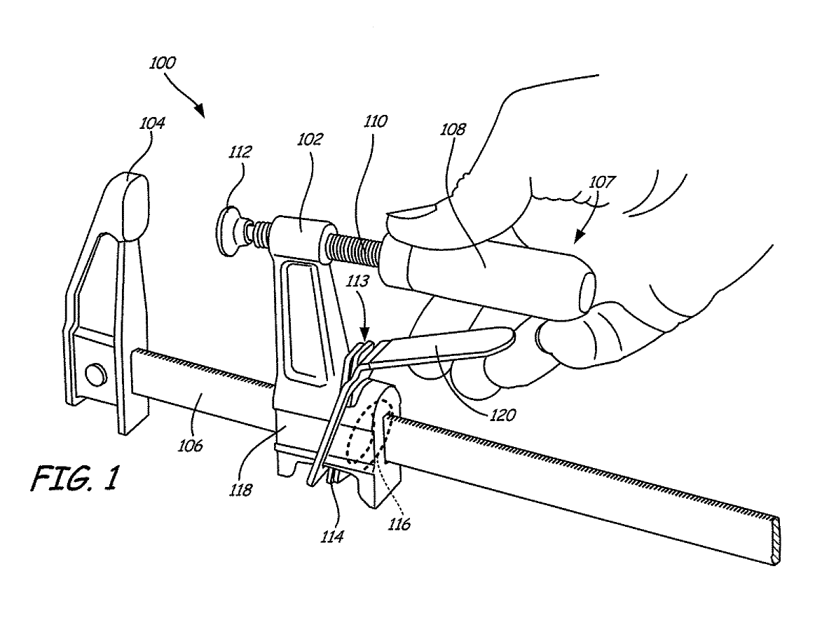

FIG. 1 is a side view of a bar clamp assembly.

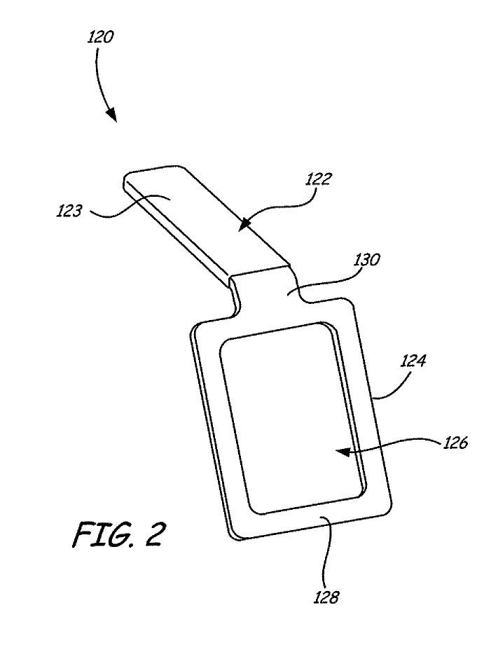

FIG. 2 is a perspective view of a quick release mechanism.

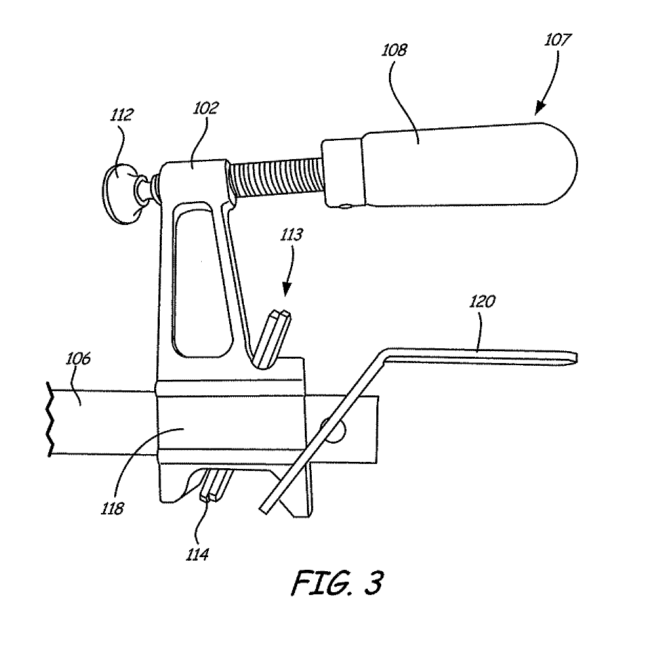

FIGS. 3-5 are side views of a sequence of a quick release mechanism engaging a stack of clutch plates.

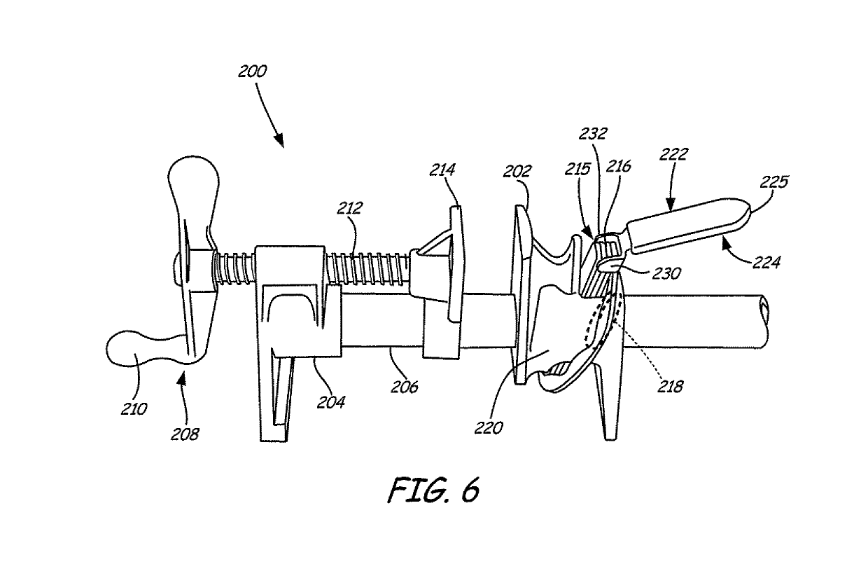

FIG. 6 is a side view of a pipe clamp.

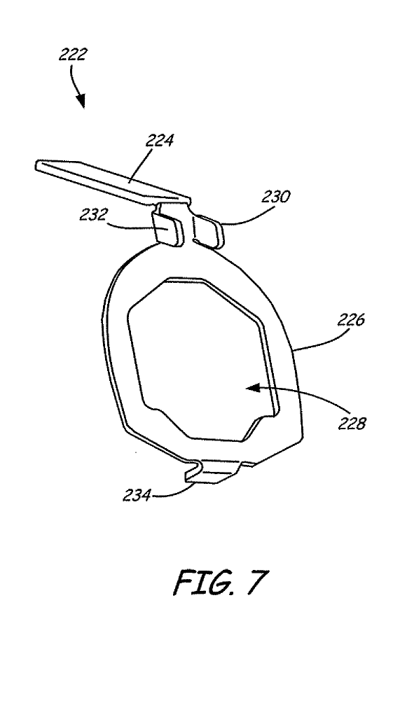

FIG. 7 is a perspective view of a quick release mechanism.

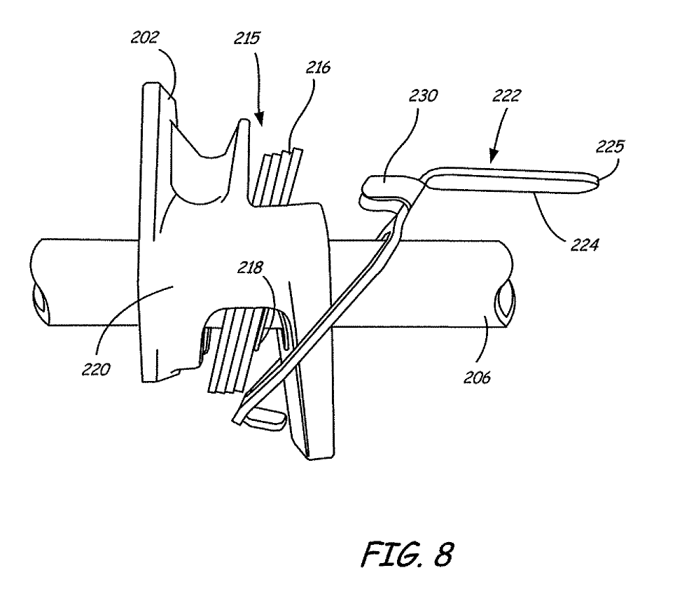

FIGS. 8-10 are side views of a sequence of a quick release mechanism engaging a stack of clutch plates.

While the above-identified figures set forth one or more embodiments of the present invention, other embodiments are also contemplated, as noted in the disclosure. In all cases, this disclosure presents the invention by way of representation and not limitation. It should be understood that numerous other modifications and embodiments can be devised by those skilled in the art which fall within the scope and spirit of the principles of this invention.

### DETAILED DESCRIPTION

FIG. 1 is a side view of a bar clamp assembly 100. Assembly 100 includes a first jaw 102 and a second jaw 104 opposed from the first jaw 102. Assembly 100 also includes a beam 106, which in this case is a bar. Jaw 102 is movable with respect to bar 106 and jaw 104 is fixed with respect to bar 106. However, jaw 104 need not be fixed with respect to bar 106.

During operation, a workpiece is inserted between jaws 102 and 104. Coupled to jaw 102 is adjustment mechanism 107 that includes a handle 108, a screw 110 and a workpiece engaging member 112. Workpiece engaging member 112 can be a swivel member coupled to screw 110. By turning handle 108, workpiece engaging member 112 moves with respect to jaw 102 such that a workpiece can be clamped between jaws 102 and 104. Movement of adjustment mechanism 107 with respect to jaw 102 can be used for small movements of workpiece engaging member 112 with respect to jaw 104.

In order to effectuate larger movements of workpiece engaging member 112 with respect to jaw 104, a stack 113 of at least one clutch plate 114 and a biasing element 116 are positioned within a housing 118 of jaw 102. By tilting stack 113 with respect to bar 106 (e.g. generally perpendicular with respect to the bar), stack 113 is released from bar 106 and thus jaw 102 can move with respect to bar 106. After releasing stack 113, biasing element 116 (e.g. a spring element) provides pressure on stack 113 such that the one or more clutch plates 114 of the stack 113 engage bar 106 and limit movement relative thereto.

A quick release mechanism 120 is provided to engage stack 113 such that operation of the stack 113 is easier. Quick release mechanism 120 can be configured to be fitted on an existing bar clamp to effectuate movement of the stack of clutch plates such that jaw 102 can move along a length of bar 106. In the embodiment illustrated, quick release mechanism 120 is positioned around an outer surface of housing 118 and on either side of stack 113. Furthermore, mechanism 120 engages stack 113 on one side (closest to jaw 104) below bar 106 and on an opposite side of stack 113 (furthest away from jaw 104) above bar 106. Thus, actuation of mechanism 120 away from bar 106 tilts stack 113 to be substantially perpendicular to bar 106 and forces stack 113 against biasing element 116. As a result, jaw 102 can move relatively freely along bar 106.

FIG. 2 is a perspective view of quick release mechanism 120. Quick release mechanism 120 can be made of hardened steel. Furthermore, quick release mechanism 120 includes a handle 122 and a clutch plate engaging portion 124. In one embodiment, handle 122 is obliquely oriented with respect to clutch plate engaging portion 124 such that handle 122 is substantially parallel to bar 106 when mechanism 120 engages stack 113. If desired, handle 122 can be provided with a suitable rubber cover 123 to allow easier grasping thereof. Clutch plate engaging portion 124 includes an aperture 126 that can be positioned around an outer surface of housing 118. When engaging stack 113, a bottom portion 128 of clutch plate engaging portion 124 engages one side of stack 113 while a top portion 130 of clutch plate engaging portion 124 engages an opposite side of stack 113.

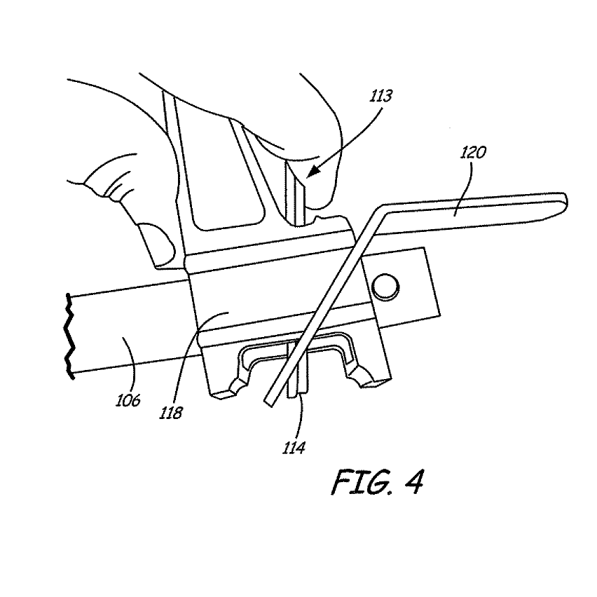

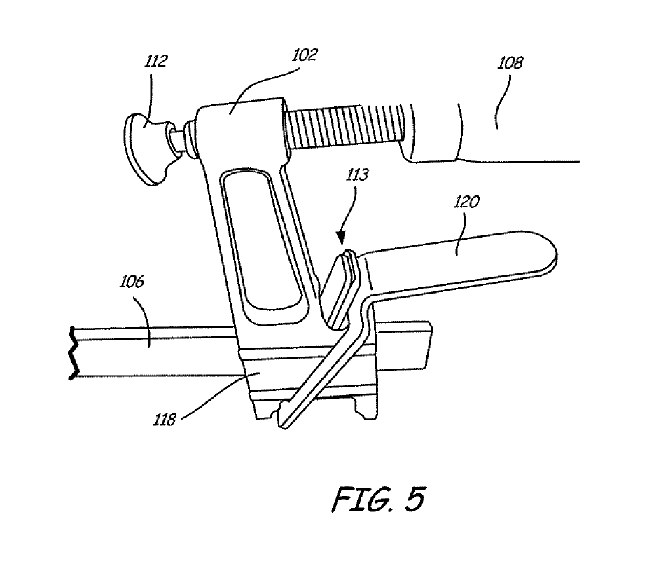

FIGS. 3-5 are a sequence of views to illustrate quick release mechanism 120 being put onto jaw 102 on bar 106, and into engagement with stack 113. Due to its unique configuration, quick release mechanism 120 can be mounted on jaw 102 without removing jaw 102 from beam 106. In FIG. 3, quick release mechanism 120 is positioned around bar 106 and housing 118 of jaw 102. In FIG. 4, clutch plate engaging portion 124 engages one side of stack 113 below bar 106. In some instances, manual actuation of stack 113 can be provided such that quick release mechanism 120 can engage stack 113. Next, in FIG. 5, quick release mechanism 120 is positioned such that clutch plate engaging portion 124 engages an opposite side of stack 113 above bar 106. Once assembled in this manner (FIG. 5) jaw 102 is more readily releasable for movement along bar 106. Thus, in order to position jaw 102 with respect to jaw 104, a person can grasp handle 122 and move handle 122 away from beam 106 (see, e.g., FIG. 1) and against the force of biasing element 116. This movement releases stack 113 from bar 106 such that large movements of jaw 102 can be made with respect to jaw 104. Releasing handle 122 allows biasing element 116 to again force stack 113 of one or more clutch plates 114 into frictional locking engagement with bar 106, thereby fixing the position of jaw 102 with respect to bar 106.

A quick release mechanism can also be used with a pipe clamp assembly. FIG. 6 is a side view of a pipe clamp assembly 200. Assembly 200 includes a first jaw 202, a second jaw 204 and a beam 206. Jaws 202 and 204 are positioned on beam 206, which in this case is a pipe. An adjustment mechanism 208 includes a handle 210, a screw 212 and a work piece engaging member 214. By turning handle 210, screw 212 and work piece engaging member 214 are actuated with respect to jaw 204. In order to move jaw 202 with respect to jaw 204, jaw 202 includes a stack 215 of one or more clutch plates 216 and a biasing element 218 (e.g., a spring element) positioned within a housing 220 of jaw 202.

A quick release mechanism 222 is provided to engage stack 215. Mechanism 222 can be configured to be positioned around an outer surface of housing 220 and on either side of stack 215. Additionally, quick release mechanism 222 engages stack 116 on one side (closest to jaw 204) below pipe 206 and engages stack 116 on an opposite side (furthest away from jaw 204) above pipe 206. Upon operation of quick release mechanism 222, stack 215 is tilted with respect to pipe 206 and forces stack 215 against biasing element 218 such that jaw 202 can move relatively freely along a length of pipe 206.

FIG. 7 is a perspective view of quick release mechanism 222, which similar to mechanism 120, can be made of hardened steel. Quick release mechanism 222 includes a handle 224 and a clutch plate engaging portion 226. As seen in FIG. 6, handle 224 may include a rubber cover 225. Clutch plate engaging portion 226 includes an aperture 228 that can fit along an outer surface of housing 220. Due to the shape of housing 220, aperture 228 includes several sides to form an efficient opening to accommodate housing 220. In the embodiment illustrated, aperture 228 includes ten sides, although other numbers of sides such as four, five or more can be used. An aperture having one or more arcuate surfaces can also be used. Clutch plate engaging portion 226 also includes side tabs 230 and 232 and bottom tab 234 extending therefrom. As seen in FIG. 6, side tabs 230 and 232 are positioned on either side of stack 215 to limit side-to-side movement of quick release mechanism 222 with respect to a top of stack 215. Bottom tab 234 limits movement of quick release mechanism 222 with respect to a bottom of stack 215.

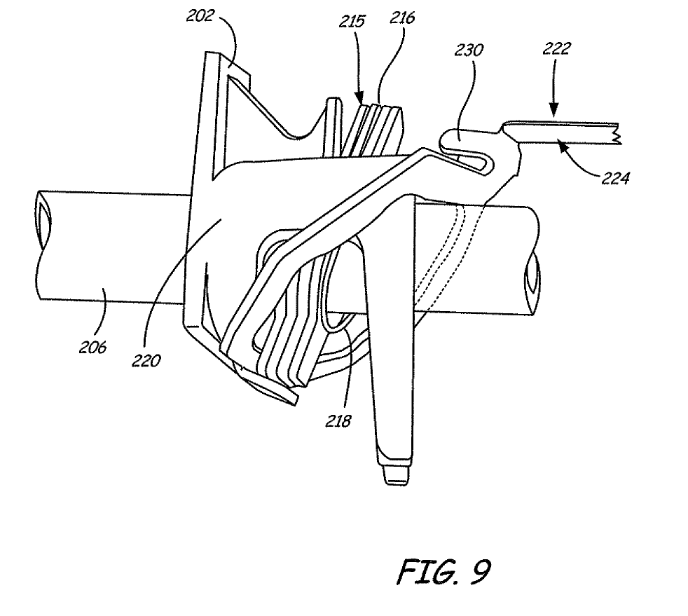

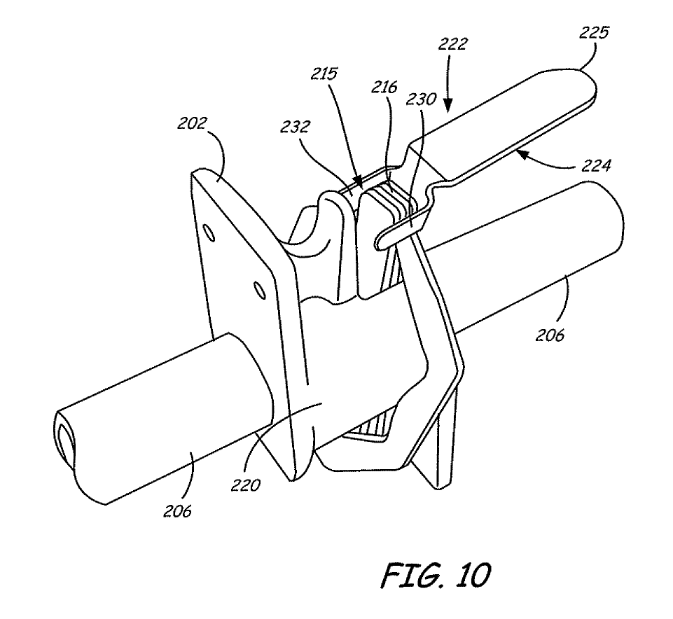

FIGS. 8-10 are views of a sequence for installation and positioning quick release mechanism 222 onto jaw 202 on pipe 206, in order to engage stack 215. Because of its unique configuration, quick release mechanism 222 can be mounted on jaw 202 without removing jaw 202 from pipe 206. In FIG. 8, clutch plate engagement portion 226 is positioned around pipe 206 and housing 220 of jaw 202. In FIG. 9, bottom tab 234 engages a bottom portion of stack 215. Next, in FIG. 10, quick release mechanism 222 is positioned such that tabs 230 and 232 are positioned on either side of stack 215. Once assembled in this manner (FIG. 10), jaw 202 is more readily releasable for movement along pipe 106. During operation, handle 224 can be actuated away from pipe 206 to disengage clutch plates 216 from pipe 206. Releasing handle 224 allows biasing element 218 to again force stack 215 of one or more clutch plates 216 into frictional engagement with pipe 206, thereby fixing the position of jaw 202 with respect to pope 206.

Although the subject matter has been described in language specific to various features and/or acts, it is to be understood that the subject matter defined in the appended claims is not necessarily limited to the specific features or acts described above. Rather, the specific features and acts described above are disclosed as example forms of implementing the claims.

What is claimed is:

1. A clamp assembly, comprising:
a beam;
a jaw including a housing disposed about the beam;
a stack including at least one clutch plate disposed within the housing; and
a quick release mechanism positioned around an outer surface of the housing, the quick release mechanism including a handle and a clutch plate engaging portion adapted to engage the stack.

2. The clamp assembly of claim 1 wherein the clutch plate engaging portion engages a first side of the stack below the beam and engages an opposite side of the stack above the beam.

3. The clamp assembly of claim 1 wherein the quick release mechanism is positioned such that movement of the handle away from the beam tilts the stack to be substantially perpendicular to the beam.

4. The clamp assembly of claim 1 wherein the beam is one of a bar and a pipe.

5. The clamp assembly of claim 1 wherein the quick release mechanism includes an aperture adapted to surround the outer surface of the housing.

6. The clamp assembly of claim 5 wherein the aperture includes at least five sides.

7. The clamp assembly of claim 1 wherein the quick release mechanism includes at least one tab extending from the clutch plate engaging portion to engage the stack.

8. The clamp assembly of claim 1 wherein the handle is obliquely oriented to the clutch plate engaging portion.

9. The clamp assembly of claim 1 wherein the stack includes a plurality of clutch plates.

10. The clamp assembly of claim 1 and further comprising a biasing element positioned within the housing to effectuate a force on the stack.

11. A quick release mechanism adapted to actuate a stack of at least one clutch plate of a clamp assembly having a beam and a jaw with a housing having the stack disposed therein, the mechanism comprising:
a handle; and
a clutch plate engaging portion adapted to be positioned around an outer surface of the housing and adapted to engage the stack.

12. The mechanism of claim 11 wherein the clutch plate engaging portion is adapted to engage a first side of the stack and a second side of the stack, opposite the first side.

13. The mechanism of claim 11 wherein the handle is adapted to be positioned such that actuating the handle in a direction away from the beam provides tilting of the stack to be substantially perpendicular to the beam.

14. The mechanism of claim 11 wherein the clutch plate engaging portion includes an aperture.

15. The mechanism of claim 14 wherein the aperture includes at least five sides.

16. The mechanism of claim 11 wherein the clutch plate engaging portion includes tabs extending therefrom and adapted to engage the stack.

17. The mechanism of claim 11 wherein the handle is obliquely oriented to the clutch plate engaging portion.

18. A method for operating a clamp assembly that includes a beam and a jaw with a housing having a stack of at least one clutch plate disposed therein, the method comprising:
providing a quick release mechanism including a handle and a clutch plate engaging portion adapted to engage the stack; and
positioning the quick release mechanism around an outer surface of the housing.

19. The method of claim 18 and further comprising actuating the handle of the quick release mechanism away from the beam to tilt the stack substantially perpendicular to the beam.

20. The method of claim 18 and further comprising:
positioning a portion of the clutch plate engaging portion on one side of the stack; and
positioning another portion of the clutch plate engaging portion on an opposite side of the stack.

21. The method of claim 18 wherein the housing is disposed about the beam.
